(19) United States
(12) Patent Application Publication
(10) Pub. No.: US 2025/0384347 A1
(43) Pub. Date: Dec. 18, 2025

(54) CLASS-CONDITIONED SYNTHETIC TABULAR DATA GENERATION

(71) Applicant: The Toronto-Dominion Bank, Toronto (CA)

(72) Inventors: Jesse Cole Cresswell, Toronto (CA); Maksims Volkovs, Toronto (CA); Taewoo Kim, Toronto (CA)

(73) Assignee: The Toronto-Dominion Bank, Toronto (CA)

(21) Appl. No.: 19/239,871

(22) Filed: Jun. 16, 2025

Related U.S. Application Data
(60) Provisional application No. 63/659,882, filed on Jun. 14, 2024.

(51) Int. Cl. G06N 20/00

(52) U.S. Cl. CPC G06N 20/00

(57) ABSTRACT

An example operation may include at least one of injecting, by a noise injection module, structured noise into input data, selecting, by at least one processor communicatively coupled to a memory on a host platform, a class-specific model from a set of trained tree-based generators, evaluating, by a fidelity monitor, synthetic tabular data, wherein the fidelity monitor transmits a retraining signal to an AI development system when the synthetic tabular data deviates from expected distributional patterns, identifying, by the AI development system, a target model based on the retraining signal, retraining, by the AI development system, the target model based on the retraining signal, transmitting, by the AI development system, a retrained model to an AI production system, replacing, by the AI production system, a deployed model with the retrained model, receiving, by the AI production system, a query from a computing device, and responding, by the AI production system, to the query using the retrained model.

### CROSS-REFERENCE TO RELATED APPLICATIONS

This application claims priority to U.S. Provisional Patent Application No. 63/659,882, filed on Jun. 14, 2024, the entire disclosure of which is incorporated by reference herein.

This application is related via subject-matter to U.S. patent application Ser. No. 18/934,282, filed on Nov. 1, 2024, and U.S. patent application Docket No. 24205-DAI-US-PAT3, entitled “GENERATING CLASS-BALANCED SYNTHETIC DATA WITH FIDELITY-GUIDED RETRAINING,” filed on Jun. 16, 2025, the entire disclosures of which are incorporated by reference herein.

### BACKGROUND

Synthetic data generation plays a role in augmenting training corpora for machine learning models, particularly in domains involving structured, tabular datasets with class balance and statistical fidelity. Traditional generative approaches often struggle to preserve class-conditional feature distributions or scale effectively across diverse class labels; accordingly, there is a demand for systems that can generate high-fidelity, label-consistent synthetic data using scalable, structure-aware modeling techniques.

### SUMMARY

One example embodiment provides an apparatus that includes an AI development system, an AI production system, and a host platform containing a memory and at least one processor, wherein the memory and the at least one processor are communicatively coupled, wherein the at least one processor is configured to inject structured noise into input data using a noise injection module, select a class-specific model from a set of trained tree-based generators, and evaluate synthetic tabular data using a fidelity monitor that transmits a retraining signal to the AI development system when synthetic tabular data deviates from expected distributional patterns, wherein the AI development system is configured to identify a target model based on the retraining signal, retrain the target model based on the retraining signal, and transmit a retrained model to the AI production system, wherein the AI production system is configured to replace a deployed model with the retrained model, receive a query from a computing device, and respond to the query using the retrained model.

Another example embodiment provides a method that includes at least one of injecting, by a noise injection module, structured noise into input data, selecting, by at least one processor communicatively coupled to a memory on a host platform, a class-specific model from a set of trained tree-based generators, evaluating, by a fidelity monitor, synthetic tabular data, wherein the fidelity monitor transmits a retraining signal to an AI development system when the synthetic tabular data deviates from expected distributional patterns, identifying, by the AI development system, a target model based on the retraining signal, retraining, by the AI development system, the target model based on the retraining signal, transmitting, by the AI development system, a retrained model to an AI production system, replacing, by the AI production system, a deployed model with the retrained model, receiving, by the AI production system, a query from a computing device, and responding, by the AI production system, to the query using the retrained model.

A further example embodiment provides a computer readable storage medium comprising instructions, that when read by a processor, cause the processor to perform at least one of injecting, by a noise injection module, structured noise into input data, selecting, by at least one processor communicatively coupled to a memory on a host platform, a class-specific model from a set of trained tree-based generators, evaluating, by a fidelity monitor, synthetic tabular data, wherein the fidelity monitor transmits a retraining signal to an AI development system when the synthetic tabular data deviates from expected distributional patterns, identifying, by the AI development system, a target model based on the retraining signal, retraining, by the AI development system, the target model based on the retraining signal, transmitting, by the AI development system, a retrained model to an AI production system, replacing, by the AI production system, a deployed model with the retrained model, receiving, by the AI production system, a query from a computing device, and responding, by the AI production system, to the query using the retrained model.

### BRIEF DESCRIPTION OF DRAWINGS

FIG. 1 is a system diagram illustrating an operating environment of a software service, according to examples and features of the instant solution.

FIG. 2A is a system diagram illustrating integration of an AI model into any decision point, according to the examples and features of the instant solution.

FIG. 2B is a diagram illustrating a process for developing an AI model that supports AI-assisted computer decision points, according to the examples and features of the instant solution.

FIG. 2C is a diagram illustrating a process for utilizing an AI model that supports AI-assisted computer decision points according to examples and features of the instant solution.

FIG. 2D is a system diagram illustrating a chatbot service that utilizes an AI model.

FIG. 3A is a system diagram illustrating an operating environment for class-conditioned synthetic tabular data generation, according to the examples and features of the instant solution.

FIG. 3B is a system diagram illustrating the core components and data flow for generating class-conditioned synthetic tabular data using recursive multi-output tree ensembles according to the examples and features of the instant solution.

FIG. 3C is a flow diagram illustrating class-conditioned synthetic tabular data generation, according to the examples and features of the instant solution.

FIG. 3D a flow diagram illustrating how a chatbot request triggers class-conditioned synthetic data generation using tree-based models and recursive integration, according to the examples and features of the instant solution.

FIG. 3E is another flow diagram illustrating how a chatbot request triggers class-conditioned synthetic data generation using tree-based models and recursive integration, according to the examples and features of the instant solution.

FIG. 4A is a flow diagram illustrating a method for class-conditioned synthetic tabular data generation service, according to examples and features of the instant solution.

FIG. 4B is another flow diagram illustrating a method for a method for class-conditioned synthetic tabular data generation service, according to examples and features of the instant solution.

FIG. 5 is a system diagram illustrating a computing environment according to the instant solution's example features, structures, or characteristics.

### DETAILED DESCRIPTION

The present instant solution relates to systems and methods for generating synthetic tabular data using class-specific, multi-output tree ensemble models. In many machine learning applications, training datasets are imbalanced, limited, or privacy-constrained, particularly in structured domains such as healthcare, operations, or the like. Existing generative models struggle to preserve class-conditional statistical integrity across high-dimensional tabular datasets and often produce generic outputs lacking diversity or fine-grained fidelity.

To address these limitations, the instant solution introduces a recursive, stage-wise generative framework that injects structured noise into a duplicated training dataset and applies class-conditioned, multi-output decision tree ensembles. Each ensemble is trained to model feature transformations across a sequence of transition stages, enabling the generation of high-fidelity, label-consistent synthetic data. A recursive integration loop applies learned transformations per timestep, and a fidelity monitor evaluates statistical divergence between generated outputs and reference distributions to selectively trigger retraining.

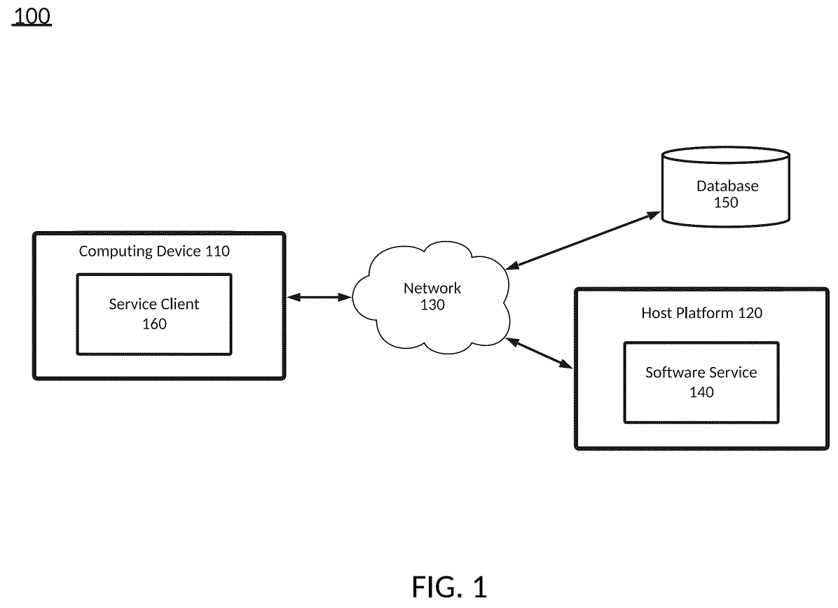

FIG. 1 is a system diagram 100 illustrating an example operating environment for the synthetic data generation solution described herein. A computing device 110 communicates with a host platform 120 via a network 130. The host platform 120 includes a software service 140 that coordinates synthetic data generation, evaluation, and retraining operations. During execution, the software service 140 may access a database 150 to retrieve training datasets, class-conditioned models, statistical thresholds, or synthetic data logs. The computing device 110 may run a service client 160, which interacts with the software service 140 to initiate data generation requests, visualize generated outputs, or review fidelity diagnostics.

The computing device 110 may include a mobile device, tablet, desktop workstation, embedded system, or any processor-equipped terminal used by a system operator or automated monitoring agent. The host platform 120 may comprise one or more physical or virtual servers, deployed on-premise, in the cloud, or within a hybrid infrastructure. The network 130 includes any suitable digital communication infrastructure, including local area networks, wide area networks, or the Internet, and may support encrypted, low-latency transport for interactive requests and telemetry.

The software service 140 provides programmatic interfaces and backend logic for invoking class-conditioned generative routines, managing ensemble model variants, and coordinating recursive synthetic data generation stages. The service may expose APIs to client applications or present interactive dashboards accessed through browser-based or native applications. The service client 160 enables users to submit prompt contexts, configure generation parameters, and monitor output fidelity or retraining outcomes through an accessible front-end.

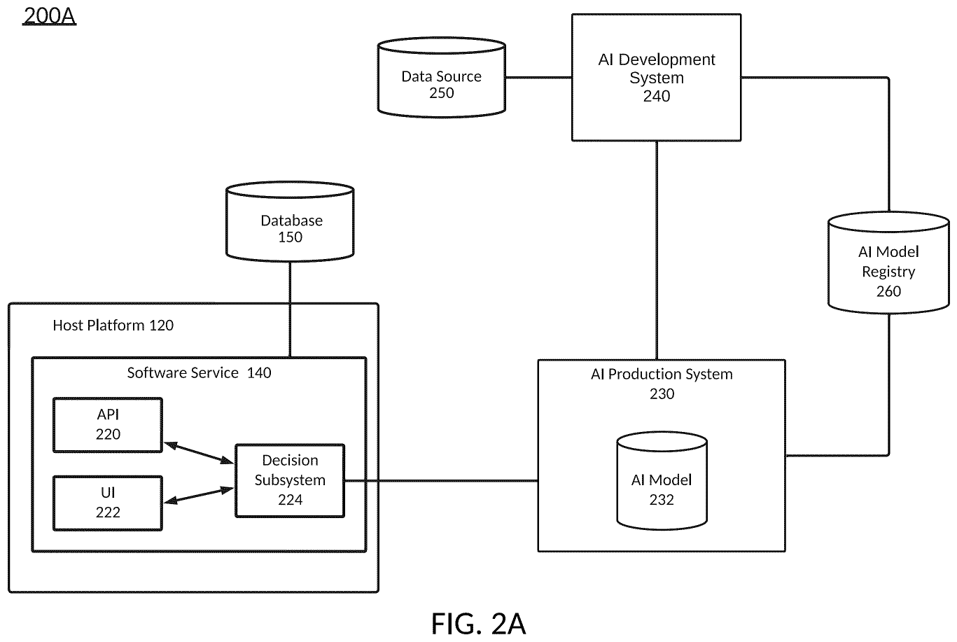

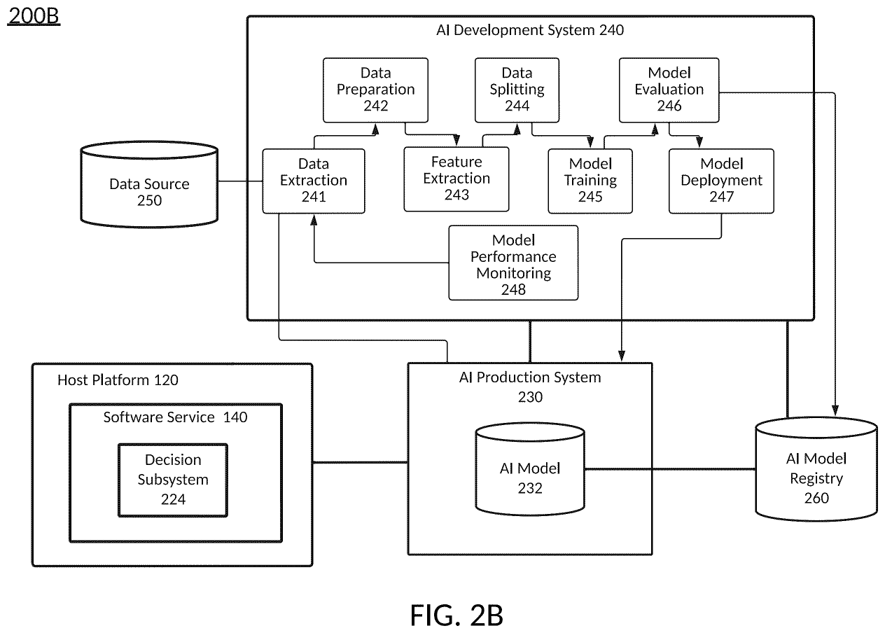

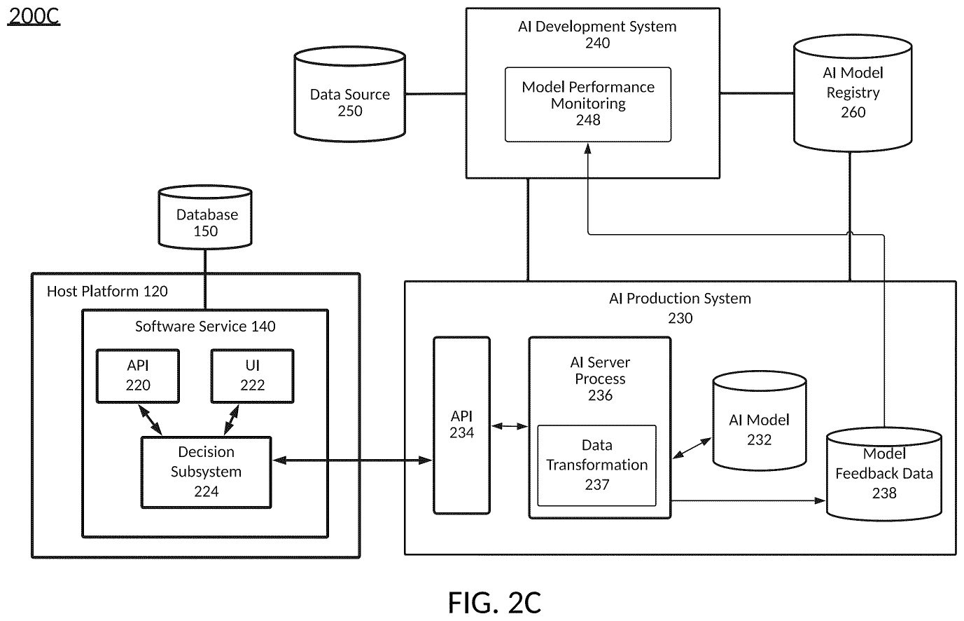

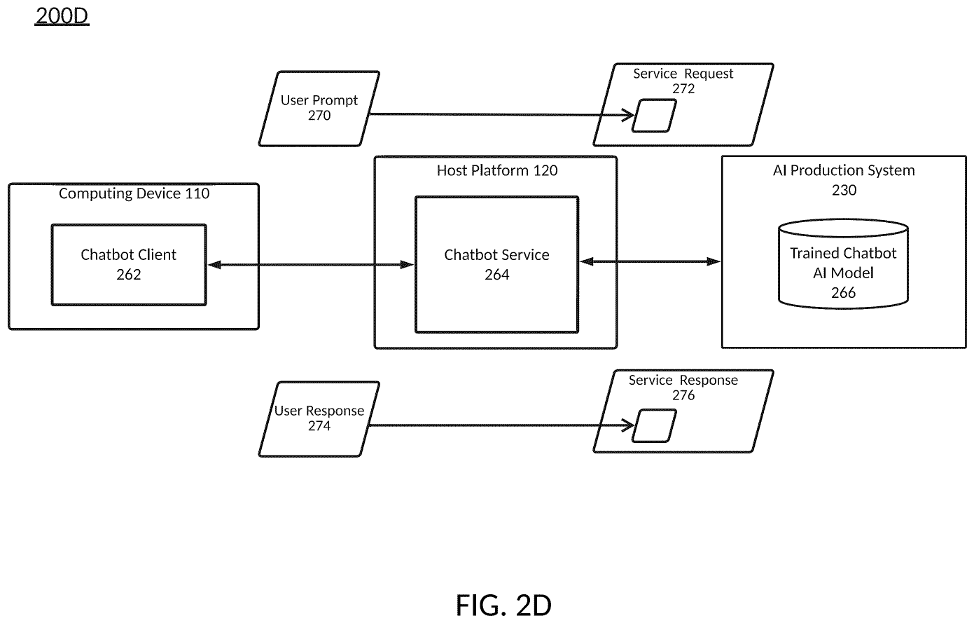

FIG. 2A illustrates an artificial intelligence architecture 200A that supports class-conditioned synthetic data generation for tabular domains within a hosted software service environment. As shown, a software service 140 executing on host platform 120 may provide programmatic and user-facing access points, including at least one application programming interface (API) 220 and at least one user interface (UI) 222. These interfaces enable external systems and users to initiate data generation requests, visualize synthetic outputs, or submit configuration parameters. The software service 140 may access a decision subsystem 224, which orchestrates the generation pipeline based on the incoming request context, model availability, and training metadata.

The decision subsystem 224 includes logic for selecting a class label based on prompt data, triggering recursive synthetic data generation routines, and evaluating fidelity of the generated outputs. Upon receiving a request, the decision subsystem invokes class-specific ensemble models and recursively generates synthetic data by interpolating across structured noise vectors and integration stages. The output of the generation process is returned through UI 222 for visualization or downstream use.

The AI production system 230 supports execution of at least one trained AI model 232. This includes class-specific multi-output tree ensembles that are invoked based on label condition. These ensembles are executed within a recursive loop governed by the decision subsystem 224, and the generated outputs may include feature vectors approximating a desired label distribution or structural pattern. In some examples and features of the instant solution, the output of the AI model 232 is a tabular dataset returned through a UI or API interface.

AI models used in the system are created and maintained by the AI development system 240. This system consumes training data from at least one data source 250, which may include real-world or synthetic datasets, to produce new or updated models. The AI development system may also receive fidelity feedback signals from the production system to selectively retrain class-conditioned model branches that underperform during inference. The development system 240 may employ batch learning workflows, pipeline-based analytics engines, and distributed model evaluation frameworks to continuously increase class-specific generative fidelity.

Once trained and validated, models are stored in an AI model registry 260. The model registry serves as a central repository accessed by both the development and production systems. In some examples and features of the instant solution, each model stored includes metadata describing its class label alignment, training version, and integration schedule, enabling the decision subsystem 224 to dynamically load the appropriate model during runtime. The registry may be implemented as a distributed model store or integrated with a hybrid edge-cloud inference system.

FIG. 2B illustrates a development and deployment architecture 200B for producing, evaluating, and managing AI models used in class-conditioned synthetic tabular data generation. The AI development system 240 is responsible for producing AI model 232 through a structured training pipeline. This pipeline begins with a data extraction step 241, in which raw or semi-structured input is loaded from at least one data source 250. This source may include historical tabular datasets categorized by class label, synthetic feedback logs, or statistical tracking data. Extraction may also include selectively retrieving class-specific sample segments for focused retraining.

Following extraction, the data undergoes data preparation 242. This step may include normalization of feature ranges per class, handling of missing or noisy values, and rebalancing of class distributions through oversampling or duplication. Data deemed statistically inconsistent or low in representation may be transformed or excluded, ensuring high-quality inputs for model training. These preparation steps enable fidelity-aware class-conditional learning in subsequent phases.

Prepared data then flows into the feature extraction module 243, where input dimensions are selected or engineered to increase model specificity. This may include extracting numerical attributes, encoded labels, and metadata fields relevant to inter-stage transitions. The feature set is structured to support multi-output regression tasks used in vector field estimation for synthetic data generation. Feature extraction may rely on internal heuristics, statistical evaluation, or template-based selectors to retain interpretability.

The extracted features are divided into training and validation sets during data splitting 244. The training set is used to fit the per-class decision tree ensemble models, while the validation set enables later tuning and accuracy checks. Data splitting may be stratified by class label to preserve generative fidelity across underrepresented categories.

The model training module 245 fits one or more multi-output tree-based models to the training data. Each class-specific model learns to predict full feature vectors as regression targets conditioned on structured noise and class identity. The module may perform hyperparameter tuning, such as tree depth or ensemble size, and measure convergence against loss functions appropriate for gradient approximation. This trained output is designated AI model 232 and is stored locally pending evaluation.

In the evaluation stage 246, the trained model is tested on validation data and optionally on unseen synthetic data distributions. Evaluation includes computing fidelity scores per class, divergence from baseline distributions, and success criteria across numerical ranges. The output of this step determines whether the model is eligible for deployment.

Validated models are stored in the AI model registry 260 and are also deployed to the AI production system 230 during model deployment 247. This enables live generation of synthetic data using the new class-specific logic. The production system may incorporate a runtime interface for initiating recursive generation, formatting tabular output, and returning fidelity diagnostics to the development system.

Throughout deployment, the development system monitors performance using model performance monitoring module 248. This module ingests usage logs, feedback scores, and runtime fidelity signals from the AI production system 230. When triggered by underperformance, such as a drop in per-class accuracy or an increase in divergence, the monitoring module activates a retraining sequence beginning with data extraction 241 and propagating through the pipeline.

The decision subsystem 224 of the software service 140 on host platform 120 acts as the orchestrator during live data generation. It selects appropriate models from AI production system 230 based on input prompt labels and transitions generation control to the recursive integration loop (see related figures).

FIG. 2C illustrates an operational process 200C for utilizing an AI model to support AI-assisted decision points during structured synthetic data generation. The architecture depicted enables a class-aware synthetic tabular data generation flow governed by model fidelity monitoring and retraining feedback.

The AI production system 230 interfaces with a decision subsystem 224 hosted within software service 140 on host platform 120. The software service 140 includes at least one API 220 and one UI 222, both of which may originate or forward requests that ultimately invoke AI model execution. The AI production system 230 exposes API 234, through which the decision subsystem 224 initiates requests to run synthetic generation routines using AI model 232.

The AI server process 236 handles inbound requests. Each request may identify a specific class-conditioned generator model and may include a payload containing input feature seeds, classification identifiers, timestep parameters, or simulation context. The AI server process 236 routes this payload through a data transformation module 237. This module reformats, enriches, or normalizes the input fields into the format expected by the AI model 232. Transformations may include adding metadata indicating the progression stage of a synthetic instance, adjusting ranges of numeric features based on class-specific statistics, or injecting structured noise to simulate generative variation.

After transformation, the AI server process 236 executes the AI model 232 with the transformed inputs. This model is typically a multi-output tree ensemble configured for recursive integration steps across discretized timesteps. The model may be selected by label and executed in its specific context to output a synthetic vector approximating a generative transport function.

The AI server process 236 returns the output to the decision subsystem 224 via API 234. The result may be used to render a preview, trigger a downstream system action, or initiate additional integration cycles. Additionally, this response may include a request ID that enables subsequent performance reporting.

Model feedback data 238 is generated post-execution and logged by the AI server process 236. Feedback data may include a summary of divergence between expected and actual outputs, classification accuracy drift, or user-confirmed alignment quality. This data is stored in model feedback data 238 and linked to the originating request via its unique ID.

The AI production system 230 also includes a feedback interface within API 234. This interface allows software service 140 to submit runtime evaluations of generated synthetic data. Feedback submissions may indicate per-class performance degradation, fidelity threshold violations, or successful alignment to statistical profiles. These evaluations are appended to model feedback data 238.

Model feedback data is either streamed continuously or retrieved on demand by model performance monitoring module 248 in AI development system 240. This enables statistical summaries, trend analysis, and the issuance of retraining triggers. Retraining may be performed using current records in model feedback data 238 and fresh samples from data source 250.

Upon identifying a fidelity concern or reaching a retraining threshold, AI development system 240 initiates a retraining process beginning with data extraction (see FIG. 2B). The updated model 232 is deployed to AI production system 230 and registered in AI model registry 260.

FIG. 2D illustrates a system diagram 200D of a chatbot service architecture that leverages a trained AI model for real-time conversational interaction. The system involves a computing device 110 hosting a chatbot client 262 that interfaces with a chatbot service 264 executing on a host platform 120. The chatbot service 264 communicates with an AI production system 230 which hosts a trained chatbot AI model 266.

The chatbot client 262 captures a user prompt 270 through a graphical interface or embedded messaging system. This prompt may include natural language text, structured queries, or voice input transcribed into text. Upon capturing the user prompt 270, the chatbot client 262 transmits the input to the chatbot service 264 via a secure application programming interface (API) endpoint.

The chatbot service 264 assembles the incoming user prompt 270 into a service request 272. This request includes contextual metadata such as a session identifier, user credentials, timestamp, device characteristics, and optionally a target model identifier pointing to the trained chatbot AI model 266. The chatbot service 264 then relays the service request 272 to the AI production system 230 for inference.

Upon receiving the service request 272, the AI production system 230 identifies the appropriate AI model instance using the provided identifier. It extracts the user prompt 270 from the payload and transforms it using Natural Language Understanding (NLU) or Natural Language Processing (NLP) techniques. These transformations may involve tokenization, entity recognition, syntactic parsing, semantic embedding, or contextual vectorization, thereby converting the prompt into a structured format suitable for model inference.

The transformed input is forwarded to the trained chatbot AI model 266. The model processes the input and generates a user response 274. This response may involve a combination of retrieval-based and generative techniques, incorporating natural language generation (NLG), context tracking, and intent fulfillment strategies.

Upon computing the user response 274, the AI production system 230 packages it into a service response 276. This response includes the generated reply along with any metadata used for auditing, latency tracking, or feedback scoring. The service response 276 is transmitted back to the chatbot service 264, which extracts the user response 274 and forwards it to the chatbot client 262.

The chatbot client 262 renders the user response 274 in its user interface, completing the conversational round-trip. Optionally, the chatbot client 262 may log the interaction and allow user feedback collection to inform future model updates.

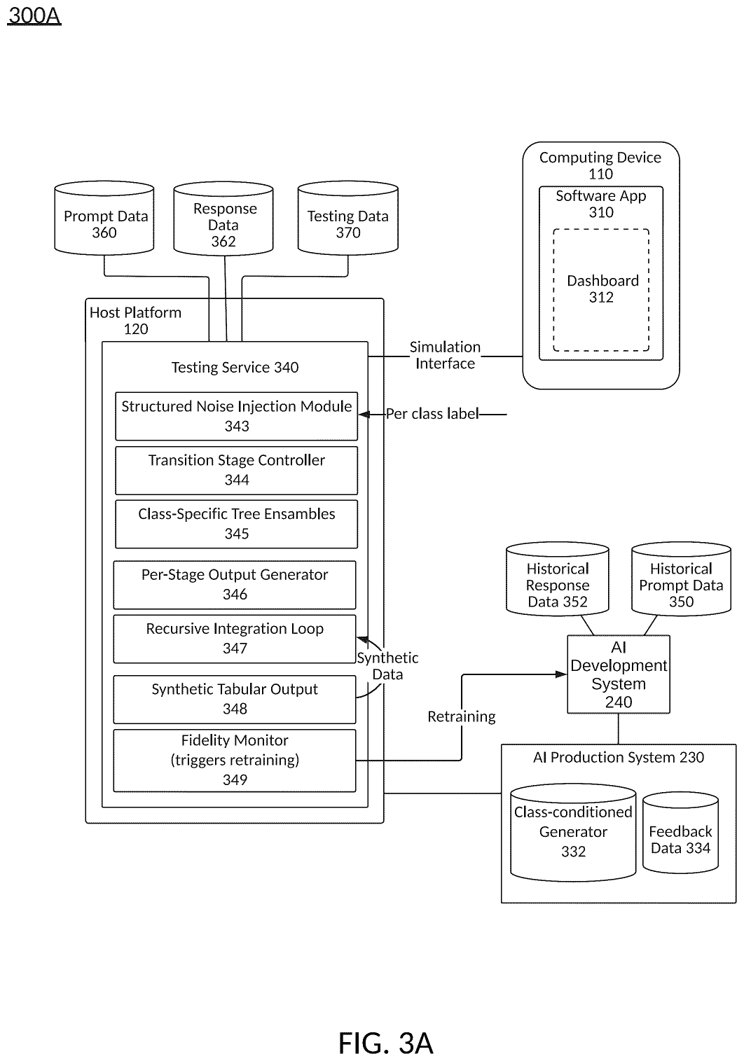

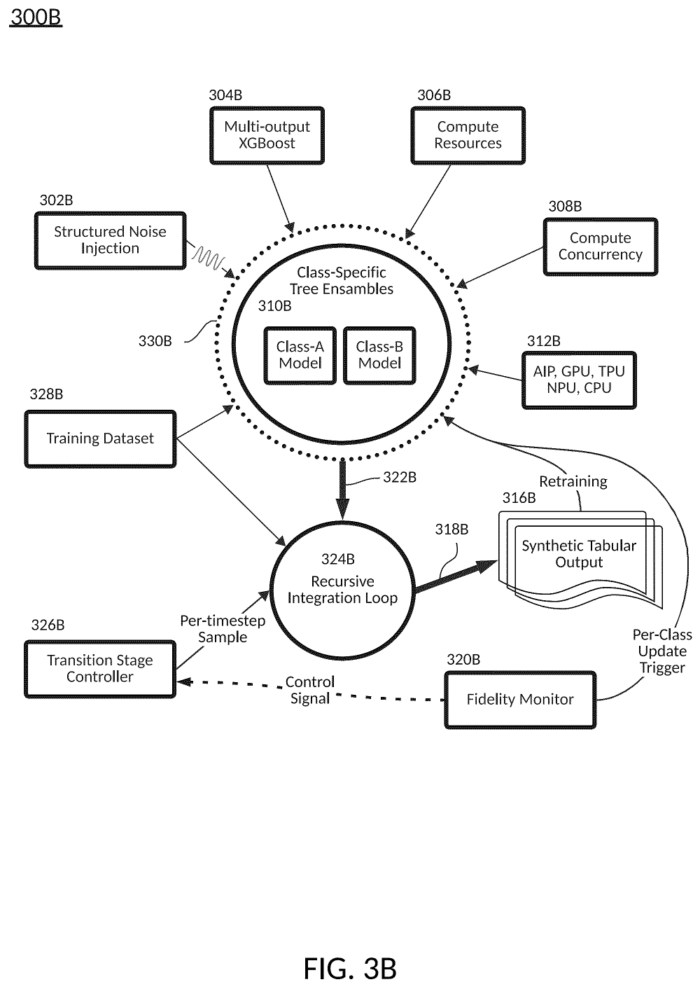

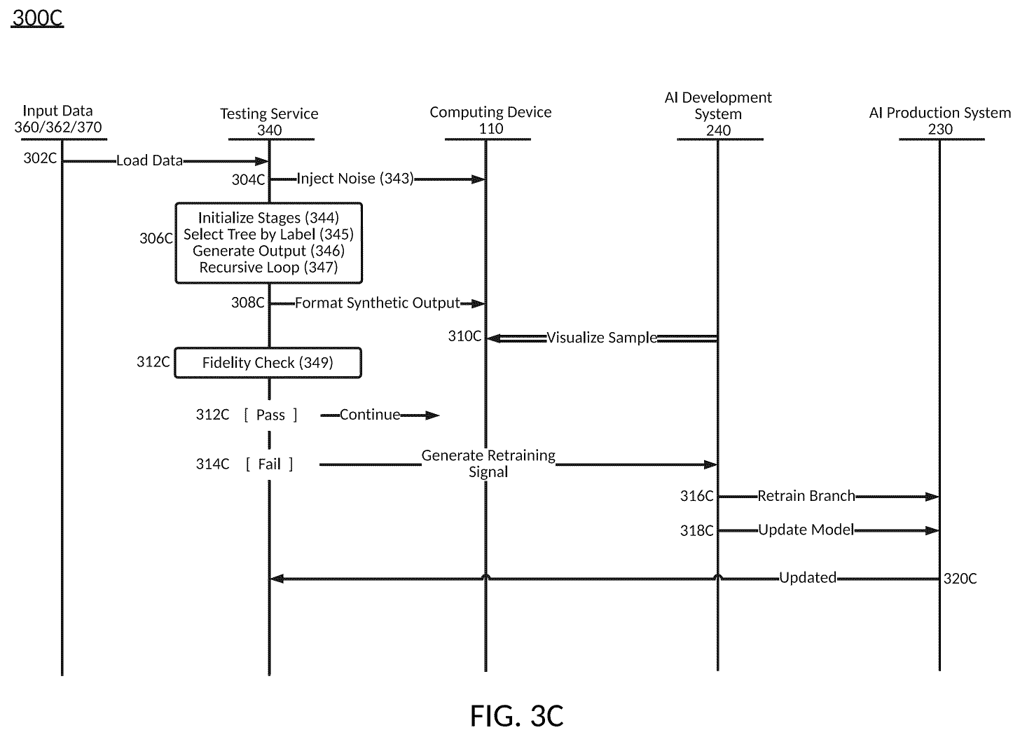

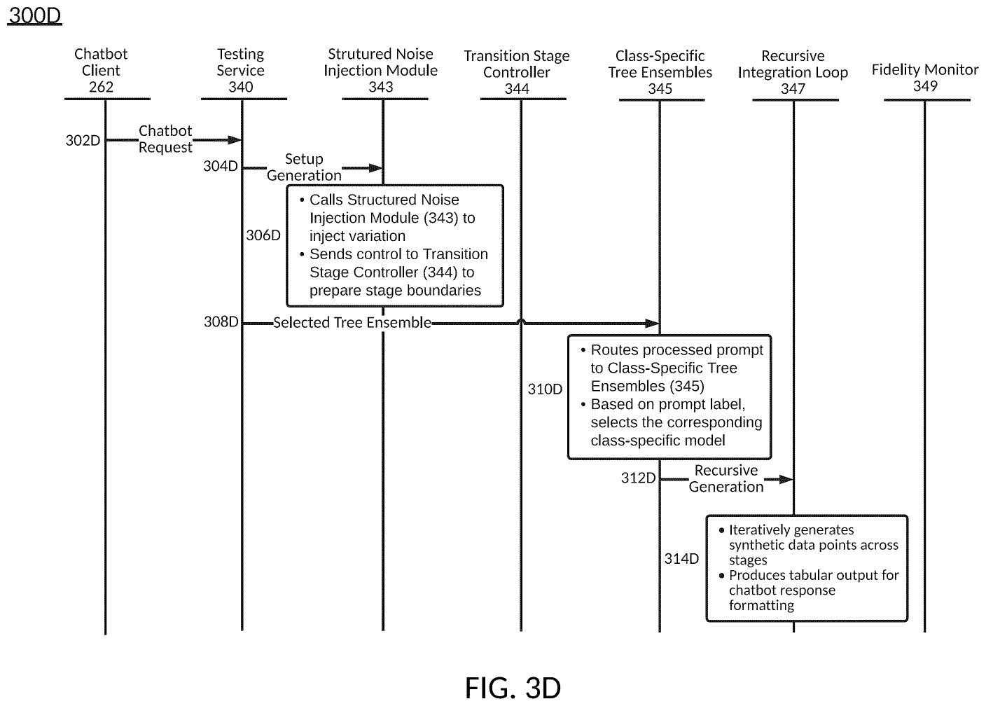

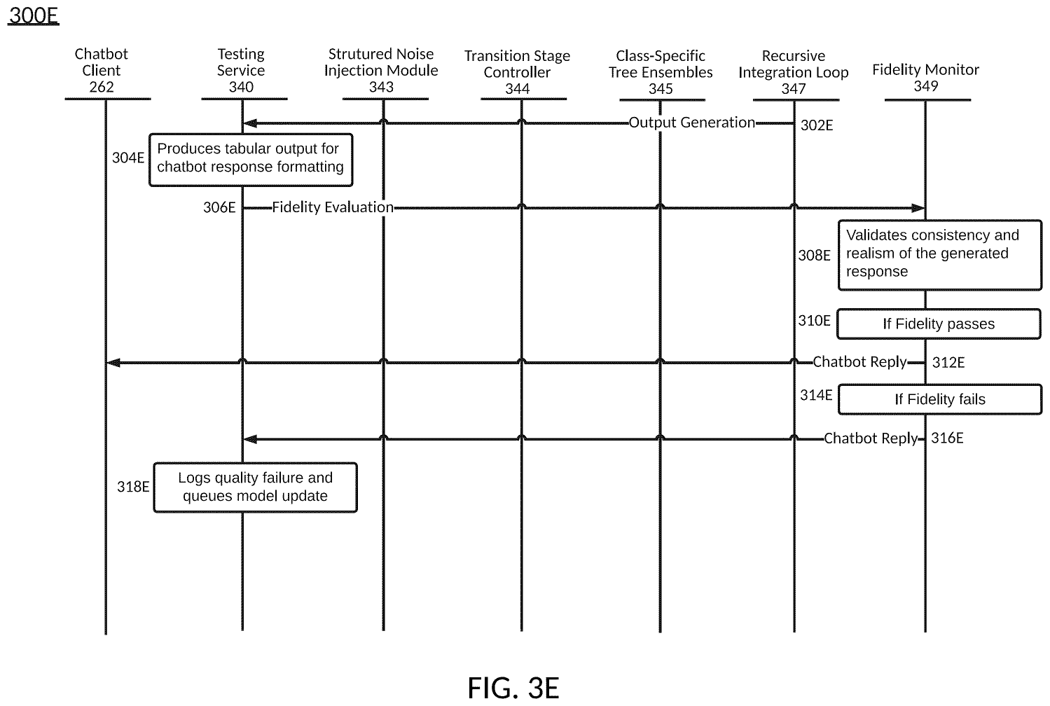

FIG. 3A is a system diagram illustrating an operating environment 300A for a synthetic data generation and fidelity evaluation service configured to simulate evolving data distributions for AI model testing and feedback-driven retraining.

The system enables the generation of tabular synthetic datasets that emulate complex class-conditioned transformations observed in real-world data over time. These generated datasets support continuous evaluation and refinement of AI models deployed in production environments. In this architecture, a host platform 120 executes a testing service 340 comprising multiple modular components designed to ingest data, transform features, generate synthetic outputs, and assess fidelity metrics.

The testing service 340 ingests at least three structured data sources: prompt data 360, response data 362, and testing data 370. These datasets serve as training inputs and fidelity baselines and are examples of data sources 250. A structured noise injection module 343 applies controlled perturbations to the input data, modulated by per-class parameters. These injected variations are used to simulate naturally occurring noise or temporal data drift.

A transition stage controller 344 defines transition phases that represent different temporal or distributional stages of a given data class. The class-specific tree ensembles 345 include multiple decision-tree-based ensemble models, where each ensemble corresponds to a classification label and is designed to model that class's progression dynamics across stages. These ensembles are trained using variants of gradient-boosted decision trees, such as multi-output XGBoost, and are deployed independently to support scalable retraining.

For each transition stage, a per-stage output generator 346 derives intermediate feature updates. These updates are sequentially composed by a recursive integration loop 347 that iteratively transforms each sample to match the target distribution associated with a later stage. The final output is emitted by a synthetic tabular output 348 module, which formats the transformed features into a coherent table structure compatible with downstream analytics or AI evaluation.

This synthetic data is then evaluated by a fidelity monitor 349. The fidelity monitor assesses the statistical consistency of the synthetic output relative to the original class-conditioned distribution. It compares divergence metrics such as KL divergence or Wasserstein distance between real and synthetic distributions. When any divergence exceeds a configured threshold, the fidelity monitor triggers a retraining request to the AI development system 240.

The AI development system 240 accesses historical prompt data 350 and historical response data 352 and retrains the corresponding ensemble (stored in the class-conditioned generator 332). Upon completion, the retrained model and updated feedback data 334 are returned to the host platform 120, completing a continuous learning loop.

A simulation interface links the testing service 340 to a computing device 110 executing a software app 310, which includes a dashboard 312. The dashboard provides real-time visualization of transition-stage outputs, synthetic fidelity metrics, and class-specific predictions, enabling analysts to inspect how changes in synthetic feature vectors affect model behavior over time. Device telemetry and inputs from this interface may also be logged and optionally fed back into the host platform for future retraining.

FIG. 3B is a system diagram illustrating an advanced synthetic data generation and fidelity monitoring architecture 300B configured for class-conditioned ensemble training and recursive feature transformation. This environment supports scalable, label-specific learning using ensemble models, facilitates dynamic synthetic data generation per timestep, and drives per-class retraining via fidelity feedback loops.

At the core of the system is the class-specific tree ensembles module 310B, which houses independent predictive sub-models such as class-A model and class-B model. Each sub-model is uniquely trained to simulate the feature distribution evolution associated with a specific class label. These ensembles receive upstream contributions from multiple system components and expose transformation logic downstream to a recursive synthesis engine.

Upstream, a structured noise injection module 302B modulates incoming data by applying controlled perturbations. This module emulates distributional drift and stochastic variation within each class context by injecting learned or parameterized noise into the data stream. This noise-modified input is then routed to the ensemble for class-specific interpretation. The interface 330B indicates such conditioned noise modulation entering the class-specific tree ensembles module 310B.

Ensemble training is supported by a training dataset 328B, containing real-world labeled examples partitioned by class. Each sub-model in the ensemble is independently fit using this dataset, enabling precise emulation of class-conditioned behavior. Training logic leverages multi-output XGBoost 304B, which extends gradient boosting to simultaneously predict multi-dimensional outcomes aligned with stage transitions or multi-attribute outputs.

Training and inference operations are further orchestrated by compute resources 306B, compute concurrency 308B, and heterogeneous execution platforms such as AIP, GPU, TPU, NPU, CPU 312B. These hardware-agnostic resource abstractions allow the system to scale across cloud, edge, or hybrid execution environments. The ensemble models are implemented to support parallelism and concurrency across sub-models and stages.

Once class-conditioned predictions are selected, the synthetic transformation proceeds through a recursive integration loop 324B. This loop receives per-class output from the tree ensembles via interface 322B and performs iterative synthesis using a feedback-controlled update mechanism. Each recursive step refines the feature vector to resemble a downstream distribution (e.g., simulating progression through stages of customer behavior or product lifecycle).

The loop receives additional feedback from a transition stage controller 326B, which supplies stage definitions and triggers sampling logic per timestep. The controller ensures proper alignment with target feature states by injecting stage-specific control signals into the recursive integration process. This enables fine-grained control over how data is transitioned and synthesized over synthetic timelines.

Synthetic outputs generated from the recursive loop are emitted to a synthetic tabular output 316B module, which serializes and formats the generated data for compatibility with standard analytics tools and downstream evaluators. These tabular outputs are generated at high throughput and with tunable structural fidelity.

Output fidelity is continuously monitored by a fidelity monitor 320B. This module evaluates per-class divergences between synthetic and real data using statistical metrics, such as Wasserstein distance, Jensen-Shannon divergence, or Mahalanobis distance. When divergence for any class exceeds a configured threshold, the fidelity monitor triggers a per-class update trigger that initiates selective retraining of the corresponding ensemble sub-model.

This retraining process is executed asynchronously and updates the affected class model within the ensemble. The updated model is injected back into the ensemble via a shared interface, preserving all other class pathways and minimizing disruption. This architecture supports temporal synthetic data simulation, targeted retraining, and concurrent inference, enabling dynamic evolution modeling in systems such as adaptive simulations, behavioral forecasting, or pre-deployment stress testing for production AI models.

FIG. 3C illustrates a sequence diagram 300C for a system that performs synthetic data generation conditioned on classification labels, integrates fidelity assessment, and supports automated retraining workflows. The diagram details the communication between the input data sources, including prompt data 360, response data 362, and testing data 370; the testing service 340; the computing device 110; the AI development system 240; and the AI production system 230.

Input data, composed of prompt data 360, response data 362, and testing data 370, is loaded 302C into the testing service 340. These datasets contain class-labeled records used to guide synthetic sample generation and evaluation. The testing service 340 invokes 304C the structured noise injection module 343 to apply targeted perturbations to the input data. This module injects class-conditioned variation into the training samples to simulate real-world anomalies or diversity in prompt-response patterns.

The control flow proceeds 306C to the transition stage controller 344, which segments the synthesis process into defined stages. These stages may correspond to semantic transitions or feature transformations. Following this, the class-specific tree ensembles 345 receive control. The module selects the appropriate sub-model, such as class-A or class-B model branches, based on the input label. Each sub-model in class-specific tree ensembles 345 has been independently trained to model data distributions and response behaviors for its respective class.

The selected class-specific model generates a sequence of intermediate outputs via the per-stage output generator 346. These outputs are passed to the recursive integration loop 347, which accumulates per-timestep updates and maintains temporal coherence across generations. The loop transforms the signal into a finalized structure and emits it 308C to the synthetic tabular output 348 for formatting.

Once formatted, the synthetic output is passed to the computing device 110, where it may be visualized, analyzed, or inspected through a user-facing dashboard or quality control tool 310C. Simultaneously, the same synthetic output is provided 312C to the fidelity monitor 349. This module computes divergence between the synthetic and real data distributions using metrics such as statistical deviation, classification error rates, or feature overlap.

The fidelity monitor 349 produces a binary outcome. When the fidelity check passes 312C, the sample is accepted and made available to downstream consumers or diagnostic pipelines. When the check fails 314C, a retraining signal is generated. This signal includes the affected label, divergence summary, and optionally metadata identifying the model path responsible for generating the sample.

The generate retraining signal is transmitted to the AI development system 240. At 316C, the system identifies the appropriate sub-model branch and initiates a retraining operation using updated model or expanded training data 318C, optionally including the original input that triggered the failure. The revised model is then sent to the AI production system 230, which updates the active inference path. An acknowledgment of the update 320C is transmitted back to the testing service 340, completing the feedback loop.

This system design allows fine-grained model governance, enabling class-specific quality control through structured noise injection module 343, class-aware modeling with class-specific tree ensembles 345, iterative data refinement using recursive integration loop 347, and divergence-aware retraining workflows mediated by the fidelity monitor 349.

The instant solution leverages the AI development system 240 to facilitate multi-output synthetic data generation using structured diffusion modeling techniques. The feature distribution synthesizer receives class-conditioned input data from the curated tabular training dataset and applies structured noise via the variance propagation engine. This noise-conditioned data is routed to the tree-based generator, which comprises a multi-output XGBoost model trained to parameterize the conditional vector field across all features simultaneously. Instead of training a distinct regressor for each feature, the booster trainer generates a unified multi-output ensemble, significantly reducing computational duplication. In parallel, the class-specific fidelity monitor continuously evaluates the generated tabular instances using a learned class-wise distribution signature to detect underperforming or divergent outputs. Upon identifying such low-fidelity results, the retraining module initiates selective booster refinement on the XGBoost tree ensemble within the tree-based generator, thereby adaptively updating model parameters without full retraining overhead. A recursive generation controller governs whether outputs are to be subjected to further refinement cycles or emitted as final synthetic instances based on preconfigured fidelity thresholds and convergence metrics. All generated tabular data instances are ultimately injected into the downstream training queue for external consumption. This configuration delivers high-fidelity, class-aware synthetic samples and significantly accelerates generation throughput by leveraging shared-memory inference, feature-synchronous modeling, and conditional retraining that operates within the memory of the AI development system 240.

The instant solution implements a generative modeling method that operates on a tabular dataset composed of input samples labeled by class, wherein the training dataset is first scaled on a per-class basis using a MinMax normalization scheme applied independently to each feature subset. This scaling procedure ensures class-specific dynamic ranges are preserved, enabling more accurate downstream flow approximation. The training dataset is then duplicated across multiple time-class combinations to increase the density and diversity of interpolation anchor points. For each of these duplicated samples, a synthetic noise vector is generated, and interpolation points are formed at each of several discretized timesteps. Regression targets are computed at these points by interpolating the data-noise pair and deriving a conditional vector field that approximates either a score function or a flow-matching gradient. To efficiently support these operations, a shared gradient cache is allocated per class and timestep, allowing tree construction logic to reuse histogram statistics, reducing memory overhead. The model trainer constructs a series of class-conditioned multi-output tree ensembles, where each leaf node emits a vector representing the offset prediction across all feature dimensions simultaneously. The leaf structure is constrained to reduce co-dependency among branches, increasing ensemble interpretability. Each ensemble is tuned by reducing tree depth, elevating the learning rate, and applying a constraint on maximum leaf weight variance to mitigate overfitting in high-dimensional feature spaces. Once trained, each ensemble is serialized using a compact binary format that eliminates redundant metadata, allowing for faster deserialization and reduced memory cost at inference. Synthetic samples are generated through numerical integration, where, at each timestep, the synthetic noise vector is updated by adding a class-specific, vector field-driven offset derived from the ensemble's forward step. These updates are distributed across multiple processing threads or hardware units, where each core executes class-conditioned ensemble prediction paths independently. This configuration accelerates synthetic data throughput while preserving fidelity and reducing interpretive overhead in high-volume deployment contexts.

FIG. 3D illustrates a system interaction diagram 300D that supports the generation of AI-assisted chatbot responses using a structured, class-conditional simulation pipeline. The illustrated components include chatbot client 262, testing service 340, structured noise injection module 343, transition stage controller 344, class-specific tree ensembles 345, recursive integration loop 347, and fidelity monitor 349. This diagram depicts a multi-stage interaction architecture where chatbot responses are simulated using synthetic data generation strategies tuned to label-specific dynamics.

Chatbot client 262 sends a chatbot request 302D to testing service 340. The chatbot request comprises a user-submitted prompt and may also include contextual parameters such as user intent labels, historical interaction tokens, session identifiers, and device-derived metadata. Testing service 340 begins the generation sequence 306D by directing 304D the prompt to structured noise injection module 343, which applies perturbation functions using probabilistic variation templates. These noise functions can be implemented using class-dependent transformation curves, Gaussian kernels, or rule-based lexical substitutions to diversify the input representation without compromising semantic intent.

The perturbed prompt is then transmitted to transition stage controller 344. This module configures a stage-based execution profile, including the number of synthesis iterations, stage boundary thresholds, and control signal propagation intervals. These parameters govern the iterative unfolding of synthetic data across subsequent modules.

Testing service 340 next issues a selection signal 308D to class-specific tree ensembles 345. At 310D, the processed prompt, labeled with class metadata and noise-augmented structure, is routed to a model container within the ensemble that is mapped to the specified label class. Each model in class-specific tree ensembles 345 is trained independently using stratified subsets of prompt-response data and optimized for domain-aligned feature prioritization. Each tree ensemble may consist of multi-output gradient boosted trees, trained using techniques such as XGBoost or similar, and configured with label-conditional node pruning and per-stage loss metrics.

The selected class-specific model sends a recursive generation 312D signal with feature metadata to the recursive integration loop 347. At 314D, this integration loop manages a forward simulation pipeline that iteratively generates synthetic data points across temporal or semantic stages. Each iteration computes a prediction using the previous output vector as part of the input, allowing temporal coherence and contextual anchoring to be maintained across recursive steps. Recursive integration loop 347 supports step-wise backpropagation of fidelity scores, adaptive transition stage refinement, and intermediate synthetic data checkpointing.

After the integration cycle completes, recursive integration loop 347 outputs a chatbot-ready response during 314D. The output is structured as a synthetic tabular object comprising aligned token slots, class-identifying feature embeddings, and optional attention masks. This tabular output supports seamless transformation into natural language text, JSON-formatted chatbot payloads, or other rendering targets.

Fidelity monitor 349, although not directly engaged in this figure, is responsible for evaluating the synthetic output in downstream interactions. It compares synthetic outputs against empirical class distributions and generates retraining triggers when outputs exhibit statistical divergence beyond predefined thresholds. The system supports dynamic retraining using feedback loops from production deployments, enabling online adaptation to evolving interaction data.

FIG. 3E illustrates a sequence interaction diagram 300E representing the quality assurance and delivery flow for chatbot responses generated through a class-conditional simulation pipeline. The participants in this interaction include chatbot client 262, testing service 340, structured noise injection module 343, transition stage controller 344, class-specific tree ensembles 345, recursive integration loop 347, and fidelity monitor 349. This configuration reflects an AI-enabled dialog generation system that integrates model validation and feedback-driven retraining control logic.

Once this tabular representation is available, the system proceeds to a fidelity evaluation phase shown as message 306E, where testing service 340 submits the structured output to fidelity monitor 349. The role of fidelity monitor 349 is to validate the statistical and semantic integrity of the chatbot-generated sample using reference distribution benchmarks derived from prior training sets or production benchmarks. Fidelity evaluation may include measuring cosine similarity to class centroids, computing label-wise Jensen-Shannon divergence and comparing syntactic complexity to historically correct samples.

During 308E, the internal operation of fidelity monitor 349 evaluates whether the sample output is both consistent and realistic for the intended classification. Fidelity is computed by comparing the generated response against empirical distributions for that label class using per-class token frequency histograms, BLEU score thresholds, and clustering-based anomaly detection metrics.

When the response passes fidelity evaluation, testing service 340 receives control during 310E. A chatbot reply, confirmed for quality, is returned to chatbot client 262, as shown by message 312E. This reply includes formatted output, such as a text string, rich media response, or structured payload, based on the original user prompt and the selected model output.

When the output fails the fidelity check during 314E, the system sends message 316E, and testing service 340 is notified of the fidelity violation. Message 316E then triggers a chatbot reply that is returned to the user, optionally accompanied by a default fallback message or confidence warning, depending on implementation.

Message 318E represents the system's ability to log fidelity failures into a centralized analytics repository. In parallel, the failure instance is enqueued for retraining consideration by a downstream orchestration system. This may include writing to a retraining signal database, flagging the affected model class in a metadata index, or transmitting metrics to AI development system 240 for retraining prioritization.

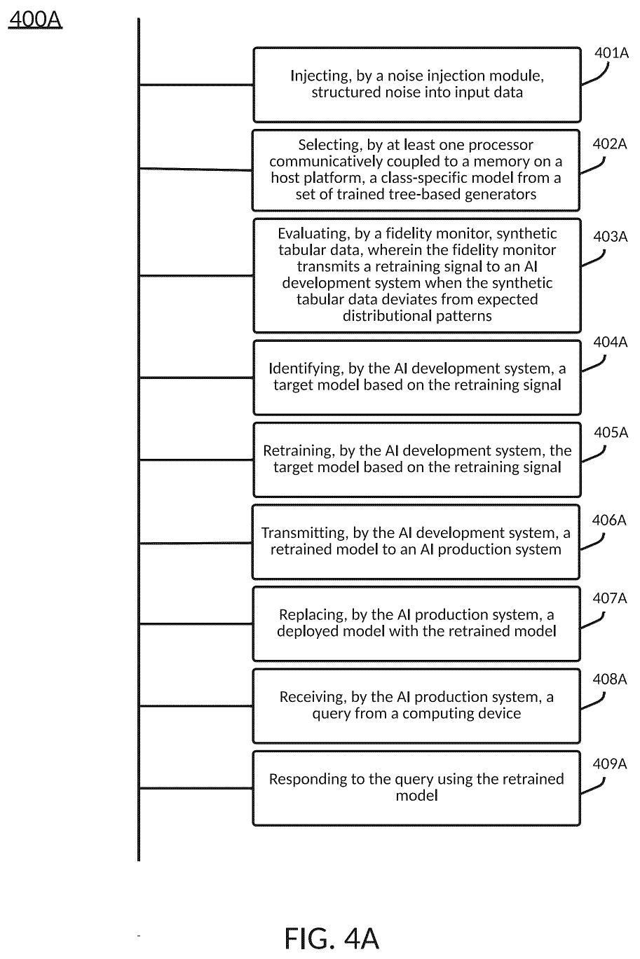

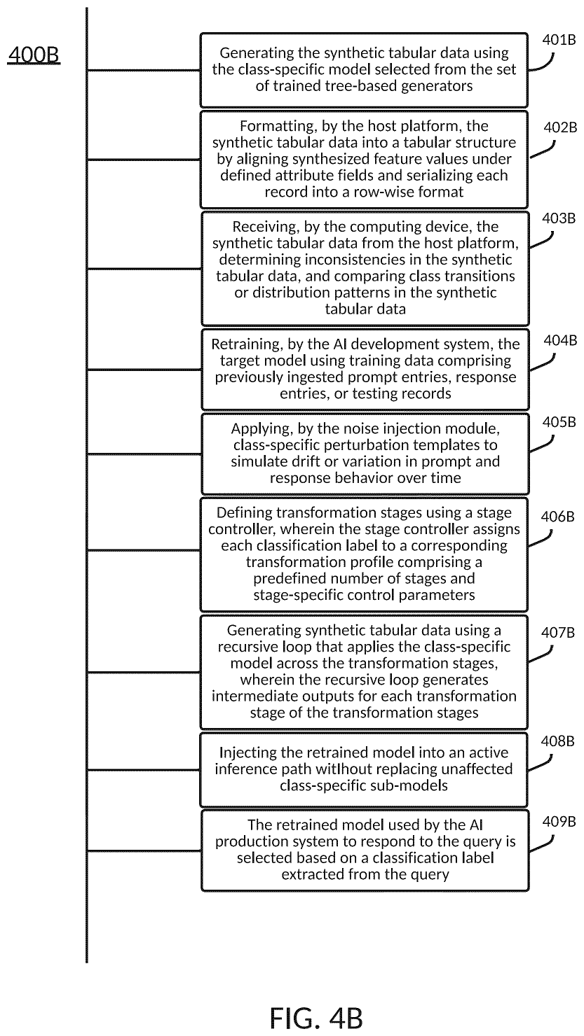

FIG. 4A illustrates an example of a method 400A for class-conditioned synthetic tabular data generation according to examples and features of the instant solution. As an example, the method 400A may be performed by a computing system, a software application, a server, a cloud platform, a combination of systems, and the like. Referring to FIG. 4A, in 401A, the method may include injecting, by a noise injection module, structured noise into input data. In 402A, the method may include selecting, by at least one processor communicatively coupled to a memory on a host platform, a class-specific model from a set of trained tree-based generators. In 403A, the method may include evaluating, by a fidelity monitor, synthetic tabular data, wherein the fidelity monitor transmits a retraining signal to an AI development system when the synthetic tabular data deviates from expected distributional patterns. In 404A, the method may include identifying, by the AI development system, a target model based on the retraining signal. In 405A, the method may include retraining, by the AI development system, the target model based on the retraining signal. In 406A, the method may include transmitting, by the AI development system, a retrained model to an AI production system. In 407A, the method may include replacing, by the AI production system, a deployed model with the retrained model. In 408A, the method may include receiving, by the AI production system, a query from a computing device. In 409A, the method may include responding to the query using the retrained model.

FIG. 4B illustrates a method 400B for class-conditioned synthetic tabular data generation according to other examples and features of the instant solution. As an example, the method 400B may be performed by a computing system, a software application, a server, a cloud platform, a combination of systems, and the like. Referring to FIG. 4B, in 401B, the method may include generating the synthetic tabular data using the class-specific model selected from the set of trained tree-based generators. In 402B, the method may include formatting, by the host platform, the synthetic tabular data into a tabular structure by aligning synthesized feature values under defined attribute fields and serializing each record into a row-wise format. In 403B, the method may include receiving, by the computing device, the synthetic tabular data from the host platform, determining inconsistencies in the synthetic tabular data, and comparing class transitions or distribution patterns in the synthetic tabular data. In 404B, the method may include retraining, by the AI development system, the target model using training data comprising previously ingested prompt entries, response entries, or testing records. In 405B, the method may include applying, by the noise injection module, class-specific perturbation templates to simulate drift or variation in prompt and response behavior over time. In 406B, the method may include defining transformation stages using a stage controller, wherein the stage controller assigns each classification label to a corresponding transformation profile comprising a predefined number of stages and stage-specific control parameters. In 407B, the method may include generating synthetic tabular data using a recursive loop that applies the class-specific model across the transformation stages, wherein the recursive loop generates intermediate outputs for each transformation stage of the transformation stages. In 408B, the method may include injecting the retrained model into an active inference path without replacing unaffected class-specific sub-models. In 409B, the method may include the retrained model used by the AI production system to respond to the query being selected based on a classification label extracted from the query.

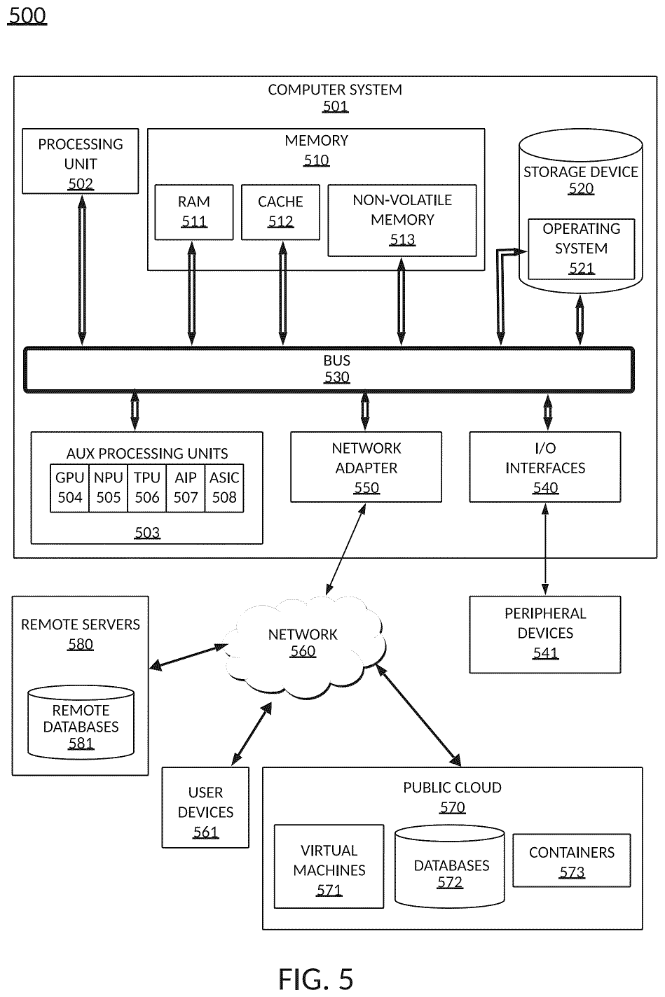

An exemplary storage medium may be communicatively coupled to the processor such that the processor may read information from, and write information to, the storage medium. In the alternative, the storage medium may be integral to the processor. The processor and the storage medium may reside in an application specific integrated circuit (ASIC). In the alternative, the processor and the storage medium may reside as discrete components. For example, FIG. 5 illustrates an example computer system architecture, which may represent or be integrated in any of the above-described components, etc.

FIG. 5 illustrates a computing environment according to the instant solution's example features, structures, or characteristics. FIG. 5 is not intended to suggest any limitation as to the scope of use or functionality of features, structures, or characteristics of the instant solution of the application described herein. Regardless, the computing environment 500 can be implemented to perform any of the functionalities described herein. In computing environment 500, there is a computer system 501, operational within numerous other general-purpose or special-purpose computing system environments or configurations.

Computer system 501 may take the form of a desktop computer, laptop computer, tablet computer, smartphone, smartwatch or other wearable computer, server computer system, thin client, thick client, network computer system, minicomputer system, mainframe computer, quantum computer, and distributed cloud computing environment that include any of the described systems or devices, and the like or any other form of computer or mobile device now known or to be developed in the future that is capable of running a program, accessing a network 560 or querying a database. Depending upon the technology, the performance of a computer-implemented method may be distributed among multiple computers and among multiple locations. However, in this presentation of the computing environment 500, a detailed discussion is focused on a single computer, specifically computer system 501, to keep the presentation as simple as possible.

Computer system 501 may be located in a cloud, even though it is not shown in a cloud in FIG. 5. On the other hand, computer system 501 may not be in a cloud except to any extent as may be affirmatively indicated. Computer system 501 may be described in the general context of computer system-executable instructions, such as program modules, executed by a computer system 501. Generally, program modules may include routines, programs, objects, components, logic, data structures, and so on that perform tasks or implement certain abstract data types. As shown in FIG. 5, computer system 501 in computing environment 500 is shown in the form of a general-purpose computing device. The components of computer system 501 may include but are not limited to, at least one processor or processing unit 502, a system memory 510, and a bus 530 that couples various system components, including system memory 510 to processing unit 502.

Processing unit 502 includes at least one computer processor of any type now known or to be developed. The processing unit 502 may contain circuitry distributed over multiple integrated circuit chips. The processing unit 502 may also implement multiple processor threads and multiple processor cores. Cache 512 is a memory that may be in the processor chip package(s) or located “off-chip,” as depicted in FIG. 5. Cache 512 is typically used for data or code accessed by the threads or cores running on the processing unit 502. In some computing environments, processing unit 502 may be designed to work with qubits and perform quantum computing.

The Auxiliary Processing Units (APU) 503 may contain at least one Graphics Processing Unit (GPU) 504, Neural Processing Unit (NPU) 505, Tensor Processing Unit (TPU) 506, AI Processor (AIP) 507, or other Application Specific Integrated Circuit (ASIC) 508. The at least one APU 503 may contain circuitry distributed over multiple integrated circuit chips. Each APU 503 may implement multiple processor threads and multiple processor cores. Each APU 503 may include at least one of onboard memory, onboard memory cache, and onboard instruction cache. Each APU may be communicatively coupled to the system bus 530 and configure to communicate with other system components, including a processing unit 502, system cache 512, RAM 511, non-volatile RAM 513, operating system 521, Network adapter 550, and Input/Output interfaces 540. In some computing environments, at least one of the at least one APU 503 may be designed to work with qubits and perform quantum computing.

Memory 510 is any volatile memory now known or to be developed in the future. Examples include dynamic random-access memory (RAM) 511 or static type RAM 511. Typically, the volatile memory is characterized by random access, but this may not be the characterization unless affirmatively indicated. In computer system 501, memory 510 is in a single package. It is internal to computer system 501, but alternatively or additionally, the volatile memory may be distributed over multiple packages and/or located externally with respect to computer system 501. By way of example, memory 510 can be provided for reading from and writing to a non-removable, non-volatile magnetic media (shown as storage device 520, and typically called a “hard drive”). Memory 510 may include at least one program product having a set (e.g., at least one) of program modules configured to carry out the functions of various features, structures, or characteristics of the instant solution of the application. A typical computer system 501 may include cache 512, a specialized volatile memory generally faster than RAM 511 and generally located closer to the processing unit 502. Cache 512 stores frequently accessed data and instructions accessed by the processing unit 502 to speed up processing time. The computer system 501 may also include non-volatile memory 513 in the form of ROM, PROM, EEPROM, and flash memory. Non-volatile memory 513 often contains programming instructions for starting the computer, including the basic input/output system (BIOS) and information to start the operating system 521.

Computer system 501 may include a removable/non-removable, volatile/non-volatile computer storage device 520. For example, storage device 520 can be a non-removable, non-volatile magnetic media (not shown and typically called a “hard drive”). At least one data interface can connect it to the bus 530. In features, structures, or characteristics of the instant solution where computer system 501 has a large amount of storage (for example, where computer system 501 locally stores and manages a large database), then this storage may be provided by peripheral storage devices 520 designed for storing very large amounts of data, such as a storage area network (SAN) that is shared by multiple, geographically distributed computers.

The operating system 521 is software that manages computer system 501 hardware resources and provides common services for computer programs. Operating system 521 may take several forms, such as various known proprietary operating systems or open-source Portable Operating System Interface type operating systems that employ a kernel.

The bus 530 represents at least one of several types of bus structures, including a memory bus or memory controller, a peripheral bus, an accelerated graphics port, and a processor or local bus using various bus architectures. By way of example, and not limitation, such architectures include Industry Standard Architecture (ISA) buses, Micro Channel Architecture (MCA) buses, Enhanced ISA (EISA) buses, Video Electronics Standards Association (VESA) local buses, and Peripheral Component Interconnect (PCI) bus. The bus 530 is the signal conduction path that allows the various components of computer system 501 to communicate.

Computer system 501 may communicate with at least one peripheral device, 541, via an input/output (I/O) interface, 540. Such devices may include a keyboard, a pointing device, a display, etc.; at least one device that enables a user to interact with computer system 501; and/or any devices (e.g., network card, modem, etc.) that enable computer system 501 to communicate with at least one other computing device. Such communication can occur via I/O interface 540. As depicted, I/O interface 540 communicates with the other components of computer system 501 via bus 530.

Network adapter 550 enables the computer system 501 to connect and communicate with at least one network 560, such as a local area network (LAN), a wide area network (WAN), and/or a public network (e.g., the Internet). It bridges the computer's internal bus 530 and the external network, exchanging data efficiently and reliably. The network adapter 550 may include hardware, such as modems or Wi-Fi signal transceivers, and software for packetizing and/or de-packetizing data for communication network transmission. Network adapter 550 supports various communication protocols to ensure compatibility with network standards. Ethernet connections adhere to protocols such as IEEE 802.3, while wireless communications might support IEEE 802.11 standards, Bluetooth, near-field communication (NFC), or other network wireless radio standards.

Network 560 is any computer network that can receive and/or transmit data. Network 560 can include a WAN, LAN, private cloud, or public Internet, capable of communicating computer data over non-local distances by any technology that is now known or to be developed in the future. Any connection depicted can be wired and/or wireless and may traverse other components that are not shown. In some features, structures, or characteristics of the instant solution, a network 560 may be replaced and/or supplemented by LANs designed to communicate data between devices in a local area, such as a Wi-Fi network. The network 560 typically includes computer hardware such as copper transmission cables, optical transmission fibers, wireless transmission, routers, firewalls, switches, gateway computers, edge servers, and network infrastructure known now or to be developed in the future. Computer system 501 connects to network 560 via network adapter 550 and bus 530.

User devices 561 are any computer systems used and controlled by an end user in connection with computer system 501. For example, in a hypothetical case where computer system 501 is designed to provide a recommendation to an end user, this recommendation may typically be communicated from network adapter 550 of computer system 501 through network 560 to a user device 561, allowing user device 561 to display, or otherwise present, the recommendation to an end user. User devices can be a wide array, including personal computers, laptops, tablets, hand-held, mobile phones, etc.

A public cloud 570 is an on-demand availability of computer system resources, including data storage and computing power, without direct active management by the user. Public clouds 570 are often distributed, with data centers in multiple locations for availability and performance. Computing resources on public clouds 570 are shared across multiple tenants through virtual computing environments comprising virtual machines 571, databases 572, containers 573, and other resources. A container 573 is an isolated, lightweight software for running a software application on the host operating system 521. Containers 573 are built on top of the host operating system's kernel and contain software applications and some lightweight operating system APIs and services. In contrast, virtual machine 571 is a software layer with an operating system 521 and kernel. Virtual machines 571 are built on top of a hypervisor emulation layer designed to abstract a host computer's hardware from the operating software environment. Public clouds 570 generally offers databases 572, abstracting high-level database management activities. At least one element described or depicted in FIG. 5 can perform at least one of the actions, functionalities, or features described or depicted herein.

Remote servers 580 are any computers that serve at least some data and/or functionality over a network 560, for example, WAN, a virtual private network (VPN), a private cloud, or via the Internet to computer system 501. These networks 560 may communicate with a LAN to reach users. The user interface may include a web browser or a software application that facilitates communication between the user and remote data. Such software applications have been referred to as “thin” desktop software applications or “thin clients.” Thin clients typically incorporate software programs to emulate desktop sessions. Mobile device software applications can also be used. Remote servers 580 can also host remote databases 581, with the database located on one remote server 580 or distributed across multiple remote servers 580. Remote databases 581 are accessible from database client applications installed locally on the remote server 580, other remote servers 580, user devices 561, or computer system 501 across a network 560. An AI/ML model described or depicted here may reside fully or partially on any of the elements described or depicted in FIG. 5.

At least one of the modules, subsystems, models, or processes described in connection with FIGS. 1 through 4B may be implemented on or deployed to one or more computing environments of FIG. 5. For example, the testing service 340 and its subcomponents including the structured noise injection module 343, transition stage controller 344, class-specific tree ensembles 345, recursive integration loop 347, synthetic tabular output 348, and fidelity monitor 349 may each be instantiated as distinct program modules running on computing system 501. These program modules may execute concurrently or sequentially across processing unit 502 and one or more auxiliary processing units 503, such as GPU 504 or AI processor 507, to perform synthetic data generation, iterative class-wise output integration, and fidelity evaluation at runtime.

In some examples and features of the instant solution, the AI model 232 used within the AI production system 230 (e.g., the class-conditioned generator 332 or trained chatbot AI model 266) may be stored in non-volatile memory 513 or on a storage device 520 local to computing system 501. Alternatively, the AI model may be served from databases 572 or containers 573 within a public cloud 570 or from remote databases 581 accessible through network 560. Model training operations (e.g., feature extraction, gradient descent optimization, and parameter evaluation) performed by AI development system 240 may utilize compute resources abstracted from virtual machines 571 in public cloud 570, as well as distributed compute environments composed of multiple computer systems 501 executing in coordination.

The AI production workflow, including the model deployment and real-time execution stages described in FIGS. 2C and 2D, may be carried out by a combination of components such as AI server process 236 and data transformation module 237, which may be instantiated in containers 573 and orchestrated across compute nodes accessible through network adapter 550. Input data for decision subsystems 224 or chatbot services 264 may originate from user devices 561, routed through network 560, and processed via the I/O interfaces 540 and peripheral devices 541 of computing system 501.

Performance telemetry, fidelity failure records, and model feedback data 238 may be streamed to model performance monitoring module 248 of the AI development system 240 and written to remote databases 581 or local memory 510, depending on the deployment configuration. Retraining pipelines initiated via feedback triggers from fidelity monitor 349 may leverage compute concurrency via AIP 507 or TPU 506 in auxiliary processing units 503, coordinating with the bus 530 to fetch data and dispatch updated model artifacts to the AI model registry 260 and AI production system 230.

Accordingly, any of the system elements depicted or described herein, including software app 310, dashboard 312, or components of host platform 120, may execute as program instructions stored in RAM 511, cache 512, or non-volatile memory 513 and operated by processing unit 502 or auxiliary processing units 503, across local or distributed environments, depending on deployment architecture.

Although an exemplary example of the instant solution of at least one of an apparatus, method, and computer readable medium has been illustrated in the accompanying drawings and described in the foregoing detailed description, it will be understood that the instant solution is not limited to the examples of the instant solution disclosed but is capable of numerous rearrangements, modifications, and substitutions as set forth and defined by the following claims. For example, the instant solution's capabilities of the various figures can be performed by at least one of the modules or components described herein or in a distributed architecture and may include a transmitter, receiver, or pair of both. For example, all or part of the functionality performed by the individual modules may be performed by at least one of these modules. Further, the functionality described herein may be performed at various times and in relation to various events, internal or external to the modules or components. Also, the information sent between various modules can be sent between the modules via at least one of a data network, the Internet, a voice network, an Internet Protocol network, a wireless device, a wired device and/or via a plurality of protocols. Also, the messages sent or received by any of the modules may be sent or received directly and/or via at least one of the other modules.

One skilled in the art will appreciate that the instant solution may be embodied as a personal computer, a server, a console, a personal digital assistant (PDA), a cell phone, a tablet computing device, a smartphone, or any other suitable computing device, or combination of devices. Presenting the above-described functions as being performed by the instant solution is not intended to limit the scope of the present instant solution in any way but is intended to provide one example of the many examples of the instant solution.

The instant solution enables a highly practical and scalable solution for generating class-conditioned synthetic tabular data suitable for downstream AI model training, testing, or simulation. In real-world environments where structured datasets are constrained by privacy concerns, data scarcity, or class imbalance, the system provides a means to generate high-fidelity, label-aligned synthetic data without requiring direct exposure to sensitive or fully annotated real records. The recursive generative framework leverages multi-output, class-specific decision tree ensembles to perform feature-level transformations across defined temporal or semantic stages, injecting structured noise to simulate realistic variance. This ensures that the resulting synthetic samples maintain class-consistent statistical fidelity and emulate meaningful progression patterns, such as disease progression, customer lifecycle evolution, or machine wear states.

The solution supports continuous fidelity monitoring, enabling automated retraining of underperforming model paths, thereby maintaining output quality across evolving distributional targets. Deploying this generative framework within an AI production pipeline allows practitioners to safely augment model training data, simulate future class behavior scenarios, stress-test deployed models under synthetic conditions, and reduce reliance on manual data collection. This makes the instant solution particularly valuable for scenarios where synthetic but realistic tabular data is used in maintaining system performance in dynamic or data-constrained environments.

In a practical application of the instant solution, a user interacts with the system via a web-based or integrated software dashboard connected to the host platform. The user begins by uploading structured input datasets comprising labeled prompts, response entries, and optionally target test records. Through the interface, the operator configures generation parameters, such as selecting target class labels, adjusting noise injection intensity, and defining the number of transformation stages for the recursive synthesis process.

As synthetic data is generated using the class-specific tree ensemble models, the operator is presented with visualizations and diagnostics, including per-stage output previews and fidelity metrics computed by the system's internal monitoring module. The operator can inspect statistical divergence reports, receive alerts for class labels with fidelity deviations, and trigger selective retraining for specific model branches. These interventions may include modifying training inputs, adjusting retraining thresholds, or annotating synthetic outputs for post-hoc validation.

Once the synthetic dataset meets the desired fidelity criteria, the operator exports the data for downstream uses such as training a machine learning classifier, validating AI model generalization, or simulating edge-case scenarios. In production contexts, the operator can enable continuous retraining loops, wherein the system autonomously monitors fidelity metrics and adapts model parameters using feedback-driven workflows.

What is claimed:

1. An apparatus, comprising:
an AI development system;
an AI production system; and
a host platform containing a memory and at least one processor, wherein the memory and the at least one processor are communicatively coupled, wherein the at least one processor is configured to:
inject structured noise into input data using a noise injection module;
select a class-specific model from a set of trained tree-based generators; and
evaluate synthetic tabular data using a fidelity monitor that transmits a retraining signal to the AI development system when synthetic tabular data deviates from expected distributional patterns;
wherein the AI development system is configured to:
identify a target model based on the retraining signal;
retrain the target model based on the retraining signal; and
transmit a retrained model to the AI production system;
wherein the AI production system is configured to:
replace a deployed model with the retrained model;
receive a query from a computing device; and
respond to the query using the retrained model.

2. The apparatus of claim 1, wherein the synthetic tabular data is generated using the class-specific model selected from the set of trained tree-based generators.

3. The apparatus of claim 1, wherein the synthetic tabular data evaluated by the fidelity monitor is formatted into a tabular structure by aligning synthesized feature values under defined attribute fields and serializing each record into a row-wise format.

4. The apparatus of claim 1, wherein the computing device is configured to
receive the synthetic tabular data from the host platform;
determine inconsistencies in the synthetic tabular data; and
compare class transitions or distribution patterns in the synthetic tabular data.

5. The apparatus of claim 1, wherein the AI development system is configured to retrain the target model using training data comprising previously ingested prompt entries, response entries, or testing records.

6. The apparatus of claim 1, wherein the noise injection module is further configured to apply class-specific perturbation templates to simulate drift or variation in prompt and response behavior over time.

7. The apparatus of claim 1, wherein the at least one processor is further configured to define transformation stages using a stage controller, wherein the stage controller is configured to assign each classification label to a corresponding transformation profile comprising a predefined number of stages and stage-specific control parameters.

8. The apparatus of claim 7, wherein the at least one processor is further configured to:
generate synthetic tabular data using a recursive loop that applies the class-specific model across transformation stages, wherein the recursive loop generates intermediate outputs for each transformation stage of the transformation stages.

9. The apparatus of claim 1, wherein the retrained model transmitted to the AI production system is injected into an active inference path without replacing unaffected class-specific sub-models.

10. The apparatus of claim 1, wherein the retrained model used by the AI production system to respond to the query is selected based on a classification label extracted from the query.

11. A method, comprising:
injecting, by a noise injection module, structured noise into input data;
selecting, by at least one processor communicatively coupled to a memory on a host platform, a class-specific model from a set of trained tree-based generators;
evaluating, by a fidelity monitor, synthetic tabular data, wherein the fidelity monitor transmits a retraining signal to an AI development system when the synthetic tabular data deviates from expected distributional patterns;
identifying, by the AI development system, a target model based on the retraining signal;
retraining, by the AI development system, the target model based on the retraining signal;
transmitting, by the AI development system, a retrained model to an AI production system;
replacing, by the AI production system, a deployed model with the retrained model;
receiving, by the AI production system, a query from a computing device; and
responding, by the AI production system, to the query using the retrained model.

12. The method of claim 11, further comprising generating the synthetic tabular data using the class-specific model selected from the set of trained tree-based generators.

13. The method of claim 11, further comprising formatting the synthetic tabular data into a tabular structure by aligning synthesized feature values under defined attribute fields and serializing each record into a row-wise format.

14. The method of claim 11, further comprising:
receiving, by the computing device, the synthetic tabular data from the host platform;
determining, by the computing device, inconsistencies in the synthetic tabular data; and
comparing, by the computing device, class transitions or distribution patterns in the synthetic tabular data.

15. The method of claim 11, further comprising retraining the target model using training data comprising previously ingested prompt entries, response entries, or testing records.

16. The method of claim 11, further comprising applying, by the noise injection module, class-specific perturbation templates to simulate drift or variation in prompt and response behavior over time.

17. The method of claim 11, further comprising defining transformation stages using a stage controller, wherein the stage controller assigns each classification label to a corresponding transformation profile comprising a predefined number of stages and stage-specific control parameters.

18. The method of claim 17, further comprising generating synthetic tabular data using a recursive loop that applies the class-specific model across the transformation stages, wherein the recursive loop generates intermediate outputs for each transformation stage of the transformation stages.

19. The method of claim 11, further comprising injecting the retrained model into an active inference path without replacing unaffected class-specific sub-models.

20. A computer program product comprising:
at least one computer-readable storage medium; and
program instructions stored on the at least one computer-readable storage medium to perform operations comprising:
injecting, by a noise injection module, structured noise into input data;
selecting, by at least one processor communicatively coupled to a memory on a host platform, a class-specific model from a set of trained tree-based generators;
evaluating, by a fidelity monitor, synthetic tabular data, wherein the fidelity monitor transmits a retraining signal to an AI development system when the synthetic tabular data deviates from expected distributional patterns;
identifying, by the AI development system, a target model based on the retraining signal;
retraining, by the AI development system, the target model based on the retraining signal;
transmitting, by the AI development system, a retrained model to an AI production system;
replacing, by the AI production system, a deployed model with the retrained model;
receiving, by the AI production system, a query from a computing device; and
responding, by the AI production system, to the query using the retrained model.
